(19) United States
(12) Patent Application Publication
(10) Pub. No.: US 2014/0325245 A1
(43) Pub. Date: Oct. 30, 2014

(54) USB Power Distribution Management System

(71) Applicant: Transistor Devices, Inc. d/b/a TDI Power, Hackettstown, NJ (US)

(72) Inventors: John Santini, Columbia, NJ (US); Gary Mulcahy, Flanders, NJ (US)

(73) Assignee: Transistor Devices, Inc. d/b/a TDI Power, Hackettstown, NJ (US)

(21) Appl. No.: 14/264,414

(22) Filed: Apr. 29, 2014

Related U.S. Application Data
(60) Provisional application No. 61/817,020, filed on Apr. 29, 2013.

(51) Int. Cl. G06F 1/26

(52) U.S. Cl. CPC G06F 1/26
USPC 713/300

(57) ABSTRACT

A system providing an optimized power delivery and management of USB power in a closed network, such as found on commercial aircraft. The system enables utilization of a limited number of AC-DC step down and isolation converters to support a multitude of USB power outlets. It provides a means of accounting for, and overcoming wire distribution losses, while also providing for voltages and power levels compatible with the USB Power Delivery Specification.

### REFERENCE TO RELATED APPLICATIONS

This application claims one or more inventions which were disclosed in Provisional Application No. 61/817,020, filed Apr. 29, 2013, entitled “System for USB Power Distribution on Commercial Aircraft”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of power supplies. More particularly, the invention pertains to a system and method for power management and load distribution.

2. Description of Related Art

Commercial passenger aircraft many times provide services to passengers in the manner of entertainment programming or internet connectivity. As these services become more pervasive there is a definite trend toward having passengers provide their own connectivity device (e.g., Computer, Tablet, or Smart Phone) and utilizing a wireless transmission network for providing content or services.

In order to enable the most number of passengers to participate in this network, a means of recharging or supplementing portable electronic device (“PED”) battery power is desired.

The Universal Serial Bus (“USB”) protocol, defined by USB Implementers Forum, Inc., provides a method for providing power through the USB to a multitude of different types of portable devices. This is defined in the USB Power Delivery Specification, initially released in July 2012. The present USB Power Delivery Specification (Rev 1.3, appendix A, page 311) provides for the following potential USB power profiles, which define a standardized set of voltages at several current ranges that are offered by USB Power Delivery Sources. Power Profiles are defined to overlap such that a Device that requires a Profile 2 Source will operate equally well when connected to a Profile 2 or any higher Profile Source.:

Profile 1—5V@2 A (10 W)

Profile 2—5V@2 A, 12V@1.5 A (18 W maximum)

Profile 3—5V@2 A, 12V@3 A (36 W maximum)

Profile 4—5V@2 A, 12V and 20V@3 A (60 W maximum)

Profile 5—5V@2 A, 12V and 20V at 5 A (100 W maximum)

A dedicated USB power network as might be used in an aircraft, as shown in prior art FIG. 1, requires an interface to the aircraft's AC power system 1 (typically 115 VAC/400 Hz). A bulk AC/DC converter 2 uses the AC power from the aircraft 1 and provides isolated DC distribution power to a power bus 3 feeding an aircraft power network 10, which is shown in the figure with an arbitrary “n” devices. Junction boxes 4a, 4b . . . 4n, tap the bus 3 to provide power to “smart” USB outlets 5a, 5b . . . 5n, which contain controllers 9a, 9b . . . 9n, to buffer the power as per the USB protocol to individual passengers' portable devices through the standard USB outlet or connector 6a, 6b . . . 6n.

The user devices are shown as laptops 11, a tablet 12, and a portable DVD player 13, although it will be understood that any device which can be powered or charged via the USB protocol might be expected to be used on an aircraft. Each device 11-13 couples to the USB connectors 6a, 6b . . . 6n, using a standard USB plug 7a, 7c, 7d, 7n, on one end of a cord 8a, 8c, 8d, 8n. The other end of the cord 8a, 8c, 8d, 8n, will have whatever connector is appropriate to the user's device, as is well known to the art.

Realization of a system such as that shown in FIG. 1 must overcome distribution losses presented by system wiring, as well as provide discrimination circuitry at each USB smart outlet that determines the level of USB power that is delivered to each individual device. As modern PED devices can require USB power levels from 2.5 to 100 W, providing a network to potentially hundreds of users presents a number of issues regarding wiring, number of converters, number of users that can be supported, and maintaining integrity of the USB power delivered to every device on the network.

In order to satisfy all potential configurations, a distribution voltage of 20V, at minimum, is required on the distribution bus 3. At the elevated power levels (and corresponding currents) seen with new generation devices, utilization of practical wire gauges such as AWG-16 or smaller can easily result in distribution wiring losses equal to a significant percentage (25% or more) of the power delivered by the Bulk AC-DC supply 2.

For an aircraft with hundreds of potential users, oftentimes there may be enough power available to satisfy all users if they are utilizing only Profile 1 or Profile 2 (up to 18 W per user), but if a significant number of users wish to operate at Profile 3, 4 or 5 (36, 60 and 100 W, respectively), the aircraft's power network will not have sufficient capacity to satisfy everyone at once.

U.S. Published Application 2013/0241284, entitled “Load Distribution System and Power Management System and Method”, and assigned to TDI Power, the assignee of the present disclosure, manages power distribution in situations where there is not enough system power available to satisfy all potential users on a network. This application is incorporated herein by reference.

### SUMMARY OF THE INVENTION

The system of the invention provides an optimized power delivery and management system for USB power in a closed network, such as found on commercial aircraft. The system enables utilization of a limited number of AC-DC step down and isolation converters to support a multitude of USB power outlets. It provides a means of accounting for, and overcoming wire distribution losses, while also providing for voltages and power levels compatible with the USB Power Delivery Specification.

### BRIEF DESCRIPTION OF THE DRAWING

FIG. 1 presents a generalized system configuration of a USB Power Distribution system of the prior art.

FIG. 2 presents a block diagram of the system.

FIG. 3 presents a detail of one of the USB smart outlets as used in FIG. 2.

### DETAILED DESCRIPTION OF THE INVENTION

The system of the invention provides an optimized power delivery and management system for USB power in a closed network, such as found on commercial aircraft. The system enables utilization of a limited number of AC-DC step down and isolation converters to support a multitude of USB power outlets. It provides a means of accounting for, and overcoming wire distribution losses, while also providing for voltages and power levels compatible with the USB Power Delivery Specification.

The system provides for USB load classification and discrimination via sensing of the delivered output current from the bulk AC-DC supply and at individual outlets. The

Bulk Supply output power is controlled in such a way that it maintains an input power level that is compatible with the power distribution limitations of the aircraft.

It will be understood that while the term “aircraft” is used herein, the system can also be configured to work in other vehicles or even in stationary applications where it is desirable to distribute power to a plurality of devices from a supply or over a network which has limited power-delivery capacity.

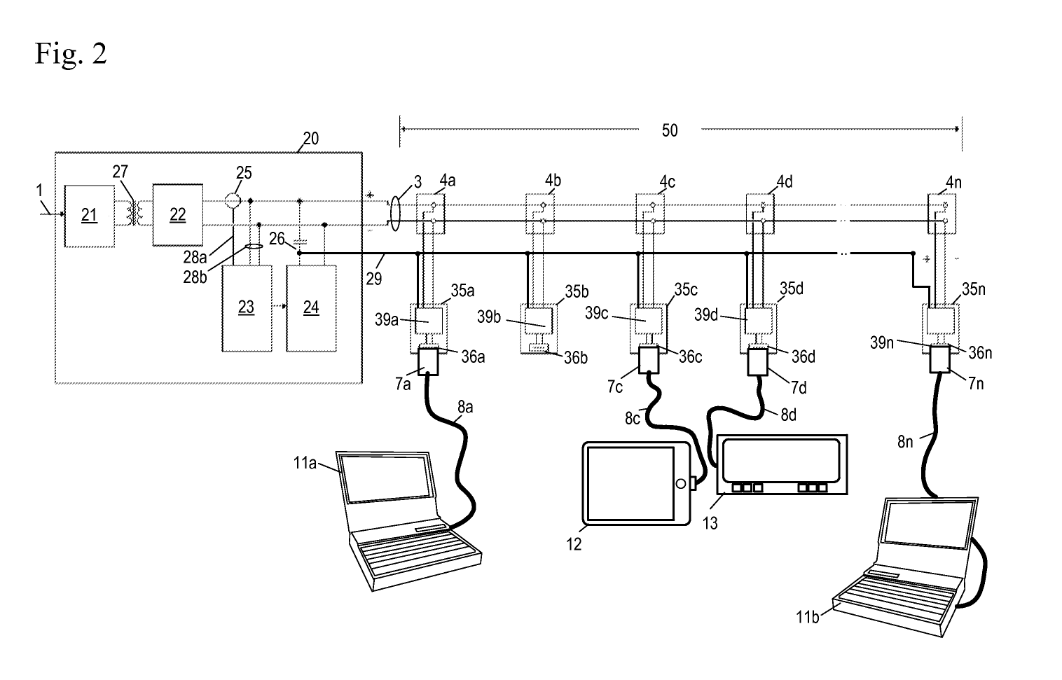

FIG. 2 shows a block diagram of a distribution system according to an embodiment of the invention. The bulk AC/DC Converter 20 of the system is fed from a supply of power, typically an aircraft power system 1 at 115 VAC 400 Hz, and provides distribution power to a distribution bus 3. Inside the bulk AC/DC converter 20, a power circuit, in this embodiment comprising a primary power circuit 21 coupled to the AC aircraft power input 1 feeding a secondary power circuit 22 through an appropriate transformer 27, converts the AC aircraft power to DC, which is then output to the distribution bus 3.

It will be understood that this power conversion function is conventional, and in other embodiments the power circuit can comprise other forms of converting whatever type, voltage or frequency of power supplied by the vehicle to the type and voltage desired by the bus.

Junction boxes 4a, 4b . . . 4n, tap the bus 3 to provide power to USB smart outlets 35a, 35b . . . 35n, which contain local control circuits 39a, 39b . . . 39n, to buffer the power as per the USB protocol to individual passengers' portable devices through the standard USB connector 36a, 36b . . . 36n.

In the system of the embodiment of the invention, the various USB smart outlets 35a, 35b . . . 35n in the network 50 can be classified for preferential or non-preferential treatment. If an outlet is classified as receiving non-preferential treatment, the power supplied to the outlet may be interrupted according to the requirements of system loading, which will be explained in greater detail below. Outlets classified for preferential treatment would be those which the configurator of the system wants to remain in operation regardless of system load. Preferential treatment outlets might be those in first class, for example, or perhaps outlets which are powering devices used by the aircraft itself (in-seat or overhead entertainment modules, perhaps, or wi-fi network access points).

In an alternative embodiment, preferential or non-preferential treatment can be assigned based on the amount of power being drawn by the device, with preference being given to either lower-power or higher-power devices, so that the system can discriminate against higher power users and provide preferred service to lower power users in place of, or in addition to, preferential treatment by location or application. Likewise, an alternative approach could be considered that provides preference to high power users in place of, or in addition to, preferential treatment by location or application.

As shown in FIG. 2, the power delivered to bus 3 for the sub-network 50 of users is monitored by output power monitor 23 which has an input 28a for sensing the output current through a current sensor 25, as well as voltage inputs 28b for sensing the voltage supplied to the bus 3 at the output of the bulk AC-DC converter 20 and a signal output. If at any point in time this power reaches a predetermined level, the output power monitor 23 initiates a power management condition on the signal output, which is input to a local system alarm generator 24. The local system alarm generator has an output 26. Note that total power delivered to the sub-network 10 is monitored in this manner, including power dissipated by distribution wiring, which can be a significant percentage of the total power.

The predetermined level or power threshold is determined by aircraft (or host system) power restrictions. The host system does not have adequate power to support all users if they chose to draw full power. This sets a requirement for power management. For example, on a wide body jet there may be 350 passengers, or more. If every passenger has a smart phone that operates at 10 W, then total power required is 350×10=3.5 kW, plus distribution wire and power conversion losses. Now, with the advent of more powerful personal electronic devices (PED's) that operate from USB, there is the possibility for having up to 350×100=35 kW of power draw. Most aircraft will not want to allocate more than 5-10 kW of engine power to support on board passenger entertainment services, therefore the requirements for power management.

The power management condition results in the local system alarm generator 24 generating a signal through its output 26. The output 26 of the local system alarm generator 24 can be coupled to the AC-DC converter 20 output and thus to the bus 3, in which case the signal can be, for example, a high frequency signal that is injected into the DC output on the bus 3. Alternatively, the signal from the output of the local system alarm generator 26 can be delivered via a separate, dedicated wire 29 that feeds to each USB smart outlet 35a, 35b . . . 35n. The power management process subjects those particular outlets that are classified as non-preferential to momentary power outages in response to the power management signals, as will be explained in greater detail below.

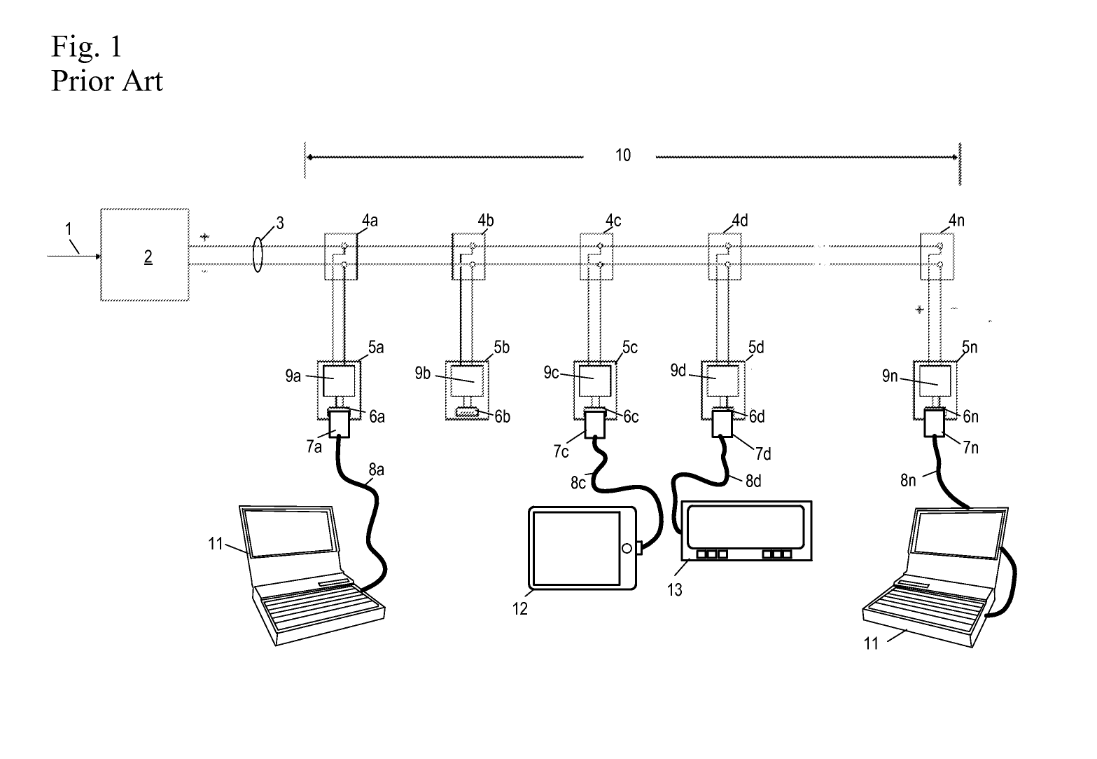

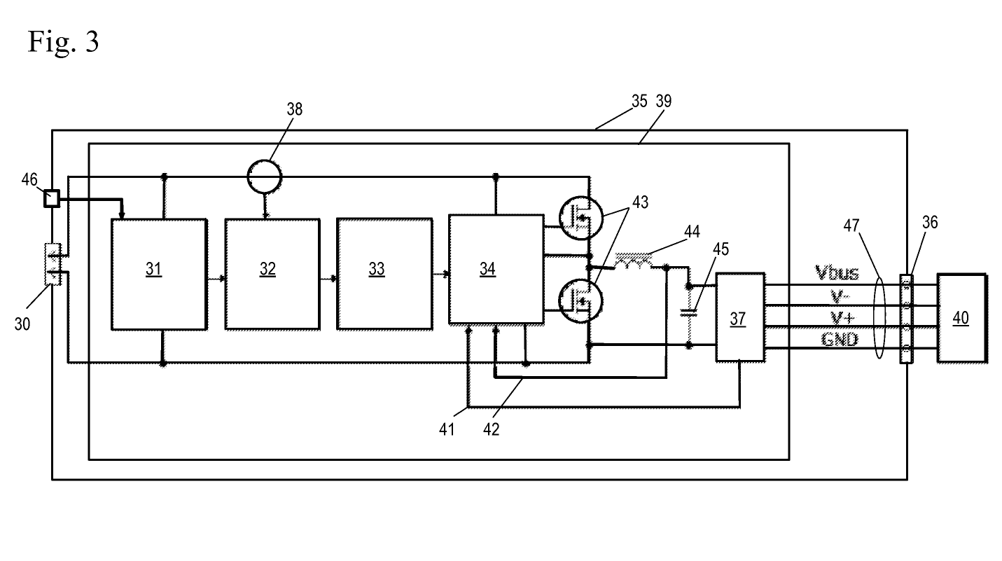

FIG. 3 shows a detail block diagram of one USB smart outlet 35. Connector 30 couples to the distribution bus 3 through wires to the nearest junction box 4a, 4b . . . 4n, as shown in FIG. 2, and feeds into local control circuit 39 in the USB smart outlet 35. The output 47 of the local control circuit 39 of the USB smart outlet 35 provides bus voltage (Vbus) and regulated lower voltage (V+, V−) and ground to USB connector 36. The user devices 40 plug into connector 36 as discussed with reference to the prior art in FIG. 1.

The local control circuit 39 has a carrier signal discriminator 31, which monitors the distributed bus voltage from connector 30 to detect power management condition signals from the local system alarm generator 24 which were impressed on the bus 3. The carrier signal discriminator 31 can alternatively (or also) connect through connector 46 to the dedicated signal wire 29, if provided, so that power management condition signals on dedicated signal wire 29 can be detected in an embodiment where such signals are used instead of (or in addition to) signals on bus 3.

An output from carrier signal discriminator 31 is coupled to a shutdown logic and timer circuit 32 to provide a signal when the discriminator 31 determines that a power management signal has been issued by the local system alarm generator 24. A current sensor 38 also allows the shutdown logic and timer circuit 32 to monitor the power being delivered by the USB smart outlet 35.

The shutdown logic and timer circuit 32 has an output coupled to a shutdown circuit 33 which has an output for a shutdown signal coupled to a control input of a DC-DC converter control circuit 34. The DC-DC converter control circuit 34 is coupled to the power input 30, and drives a regulator circuit 43 (shown in the figure as an arrangement of transistors) to regulate the output voltage of the USB smart outlet 35. The output of the regulator 43 is coupled to the input of USB interface circuit 37, optionally through a filter (here shown as an inductor 44 and capacitor 45). The USB interface circuit 37 controls the output 47 in accordance with the USB Power Distribution Specification.

The operation of the system, as installed in an aircraft, will now be explained. For the purposes of this example, as shown in FIG. 2, laptop 11a has been plugged into smart outlet 35a, tablet 12 is plugged into smart outlet 35c, DVD player 13 has been plugged into smart outlet 35d, and tablet 11b has been plugged into smart outlet 35n. It can be assumed that there are a large number of other devices on the other smart outlets between 35d and 35n which aren't shown in the figure, which place a varying load on the bus 3 as devices are plugged and unplugged, charging and completed charging, or changed in function.

For the purposes of this example, assume that at least smart outlet 35n is in first class, and has therefore been classified for preferential treatment, while smart outlets 35a-35d (and some portion of the other outlets which aren't shown) are in coach and classified for non-preferential treatment.

As the occupants of the seats in the aircraft begin to plug devices into the smart outlets 35a . . . 35n on the bus 3, and the devices begin to draw current, the total power delivered onto the bus 3 by the bulk AC-DC converter 20 increases. The output power monitor 23 monitors current on the bus 3 through current sensor 25 coupled to its input 28a and also monitors the bus voltage through its input 28b. By Ohm's law, power is equal to current times voltage, so by monitoring current and voltage on bus 3, the power monitor 23 can determine the total power being delivered to bus 3 by AC-DC converter 20.

The output power monitor 23 compares the total power being delivered to the bus 3 to a maximum power value determined to maintain power system integrity and not exceed system capacity.

For the purposes of this example, assume that the maximum power value implemented in the system of FIG. 2 was 400 Watts. With a 20 Volt bus voltage, that would give a bus current of 20 Amps. Assume that all of the devices currently plugged into the network 50 are drawing 390 Watts from the converter 20 (19.5 Amps at 20 Volts).

Now, assume that the user at the seat serviced by smart outlet 35a inserts plug 7a on cord 8a into USB connector or connector 36a. The battery in laptop 11a is low, so it immediately begins drawing 20 Watts from the bus through local control circuit 39a. This brings the total power consumption on bus 3 to 410 Watts, which exceeds the selected 400 Watt maximum. Output power monitor 23 detects this, and raises a power management condition, which causes local system alarm generator 24 to generate a power management signal on its output 26 which is, for the purposes of this example, impressed as a high-frequency signal upon bus 3, although it will be understood that the power management signal can also (or alternatively) be fed to separate signal wire 29.

The carrier signal discriminator 31 in each of the local control circuits 39a . . . 39n detects the power management signal on the bus 3 (or on the wire 29), and provides a signal to shutdown logic and timer circuit 32. The shutdown logic and timer circuit 32 determines if preferential or non-preferential treatment applies. If “non-preferential treatment” applies, that means that the connector 36 is eligible for a potential momentary outage.

In one embodiment, the shutdown logic and timer circuit 32 could be configured to always consider its connector 36 to be subject to either “preferential” or “non-preferential” treatment. The shutdown logic and timer circuit 32 can also sense the actual power being drawn by the connector 36, and can assign “preferential” or “non-preferential” treatment to power consumption which is either above or below a selected threshold.

Thus, within the teachings of the invention, the shutdown logic and timer circuit 32 could be configured to implement combinations of the two, so that the connector 36 could be designated, for example, as “always preferential” (i.e. never turned off), “preferential with a power limit” (i.e. turned off only if power drawn exceeds a threshold), “always non-preferential” (i.e. always eligible for shutdown) or “non-preferential if over a threshold” (i.e. eligible for shutdown unless the power drawn is below a threshold where shutting off the power would only have a negligible effect on total system draw). It will be understood that other factors might also be implemented in the designation of the connector 36 as eligible or ineligible for shutdown within the teachings of the invention.

Upon receipt of the signal from the carrier signal discriminator 31, if it determines that the connector 36 is eligible for shutdown based on designation, power draw, or a combination of those factors (and possibly others) as explained above, the shutdown logic and timer circuit 32 starts a timer having a randomized delay value. When the timer delay is up, if there is still a signal from the carrier signal discriminator 31, the shutdown logic and timer circuit sends a signal to the shutdown circuit 33, which in turn controls the DC-DC converter control 34 to shut down the power supplied to the connector 36.

This reduces the total power delivered by the system on bus 3 by the amount of power that had been delivered by that outlet. If this reduction in power lowers system power by an adequate amount, the power management signal will be de-asserted and all remaining outlets on the local network will remain on.

If the reduction in power does not lower system power by an adequate amount, the power management signal will remain asserted until enough outlets reach a shutdown condition so that the power management signal is turned off.

In this example, assume that the shutdown logic and timer circuit 32 in smart outlet 35d is the first to time out. The connector 36d powering DVD player 13 is shut off. Because the DVD player 13, like most portable devices, has sufficient battery power to power the device for some time, the user does not notice the interruption. The DVD player 13 is only drawing five Watts, though, so the total power draw on bus 3 is reduced only to 405 Watts, which is still over the maximum, so the power management signal remains active.

The shutdown logic and timer circuit 32 in smart outlet 35n is the next to time out. However, since this outlet has been assigned preferential treatment, the connector 36n powering laptop 11b remains live.

Next, the shutdown logic and timer circuit 32 in smart outlet 35c times out. The connector 36c powering tablet 12 is shut off. Again, because the tablet 12 has sufficient battery power, the user does not notice the interruption. The tablet is drawing 25 Watts, which when the connector 36c is shut off, reduces the total power draw on bus 3 is to 380 Watts. This is under the maximum, so the output power monitor 23 turns off the power management condition, and in response the local system alarm generator de-asserts the power management signal.

Once an outlet is shut off, the shutdown logic and timer circuit 32 starts a second timer. The shutdown signal provided to the shutdown circuit 33 is maintained until the second timer delay expires, ensuring that the connector 36 will remain off for the predetermined amount of time set by the second timer. After the second timer delay elapses, the shutdown signal will be de-asserted, and the connector 36 will resume providing power. If this recommencement of power increases total power back above the maximum, the power management signal will once again be issued by the output power monitor 23, starting the random shutdown delays in the smart outlets once again, shedding system load outlet-by-outlet until the total power draw is once again under the maximum.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A power management system comprising:
a) a power converter, comprising;
i) a power supply having an input coupled a supply of power and a DC output; and
ii) an output power monitor sensing power delivered by the power converter to the DC output, having a signal output, the output power monitor being configured to initiate a power management condition on the signal output when the power delivered by the power converter exceeds a predetermined level;
b) a distribution bus coupled to the DC output of the power supply and to the signal output of the output power monitor;
c) a plurality of local smart outlets, each comprising:
i) a power input coupled to the distribution bus;
ii) a local control circuit having an input coupled to the power input and an output, comprising:
A) a carrier signal discriminator having an input coupled to the distribution bus and an output, the carrier signal discriminator being configured to provide a signal when the carrier signal discriminator determines that a power management condition has been issued by the output power monitor;
B) a shutdown logic and timer circuit comprising an input coupled to the output of the carrier signal discriminator, a timer having a first time delay, and an output; the shutdown logic and timer circuit being configured to start the timer upon detection of the signal on the output of the carrier signal discriminator, and upon expiration of the first time delay, if the signal on the output of the carrier signal discriminator is still present, raising a shutdown signal on the output; and
C) a power regulator having an input coupled to the power input, a control input coupled to the output of the shutdown logic and timer circuit, and at least one output supplying regulated power, the power regulator being configured to stop supplying regulated power to the at least one output in response to the shutdown signal from the shutdown logic and timer circuit on the control input; and
iii) a USB connector for powering a device, coupled to the at least one output of the power regulator of the local control circuit.

2. The power management system of claim 1, in which the shutdown logic and timer circuit further comprises a second timer having a second time delay, the second timer being started when the shutdown logic and timer circuit starts the shutdown signal, and the shutdown logic and timer circuit is configured to discontinue the shutdown signal upon expiration of the second time delay.

3. The power management system of claim 2, in which the second time delay is randomized

4. The power management system of claim 1, in which the first time delay is randomized

5. The power management system of claim 1, in which the shutdown logic and timer circuit further senses power being delivered to the USB connector, and the shutdown logic and timer circuit is configured to raise the shutdown signal only if the power being delivered to the USB connector exceeds a threshold level.

6. The power management system of claim 1, in which the shutdown logic and timer circuit further senses power being delivered to the USB connector, and the shutdown logic and timer circuit is configured to raise the shutdown signal only if the power being delivered to the USB connector is less than a threshold level.

7. The power management system of claim 1, in which the shutdown logic and timer circuit is configured to raise the shutdown signal only if the outlet is designated to be eligible for power interruption.

8. The power management system of claim 1, in which the power management condition from the output power monitor is impressed upon the distribution bus as a high-frequency AC signal.

9. The power management system of claim 1, in which the distribution bus further comprises a signal wire, and the power management condition from the output power monitor is impressed upon the signal wire of the distribution bus.

10. A method of controlling a power management system comprising a power converter coupled a supply of power and supplying power over a distribution bus through a DC output to a plurality of local smart outlets delivering power from the distribution bus to devices coupled to the smart outlets, the method comprising:
a) sensing power delivered by the power converter to the distribution bus;
b) initiating a power management condition on the distribution bus when the power delivered by the power converter exceeds a predetermined level;
c) each local smart outlet performing the steps of:
i) determining that a power management condition has been initiated on the distribution bus and starting a first delay on a timer;
ii) upon expiration of the first time delay, if the power management condition is still present, shutting down power delivery to devices coupled to the smart outlet.

11. The method claim 10, further comprising the steps, following step (c) (ii), of starting a second time delay when the power delivery is shut down, and resuming power delivery to the devices upon expiration of the second time delay.

12. The method of claim 11, in which the second time delay is randomized

13. The method of claim 10, in which the first time delay is randomized

14. The method of claim 10, in which in step (c) (i) the smart outlet further senses power being delivered to devices by the smart outlet, and in step (c) (ii) power delivery is shut down only if the power being delivered exceeds a threshold level.

15. The method of claim 10, in which in step (c) (i) the smart outlet further senses power being delivered to devices by the smart outlet, and in step (c) (ii) power delivery is shut down only if the power being delivered is less than a threshold level.

16. The method of claim 10, in which in step (c) (ii) power delivery is shut down only if the smart outlet is designated to be eligible for power interruption.
